(19) United States
(12) Patent Application Publication
(10) Pub. No.: US 2002/0124682 A1
(43) Pub. Date: Sep. 12, 2002

(54) Vehicle steering wheel

(75) Inventor: Dominik Schutz, Waldaschaff (DE)

Correspondence Address: TAROLLI, SUNDHEIM, COVELL,, TUMMINO & SZABO L.L.P., 1111 LEADER BLDG., 526 SUPERIOR AVENUE, CLEVELAND, OH, 44114-1400, US

(73) Assignee: TRW Automotive Safety Systems GmbH & Co.KG

(21) Appl. No.: 10/083,079

(22) Filed: Feb. 26, 2002

(30) Foreign Application Priority Data
Mar. 6, 2001 (DE) 201 03 891.9

(51) Int. Cl. B62D 1/04

(52) U.S. Cl. 74/552

(57) ABSTRACT

The invention relates to a vehicle steering wheel comprising a skeleton embedded in a foam casing and a covering cap having an edge. The covering cap, for actuation of a horn, is mounted so as to be displaceable in an axial direction, the foam casing of the skeleton adjoining the edge of the covering cap. Guides for the covering cap are provided in a region of the edge of the covering cap. The guides are arranged such and elastically mounted such that upon laterally pressing down the covering cap for actuating the horn, the guides are tilted allowed by a yielding of the foam casing.

### TECHNICAL FIELD

The invention relates to a vehicle steering wheel. In particular, the invention relates to a vehicle steering wheel with a gas bag module mounted displaceably for actuating a horn.

### BACKGROUND OF THE INVENTION

Known vehicle steering wheels comprise a skeleton embedded in a foam casing, and a covering cap. The covering cap, for actuation of the horn, is mounted so as to be displaceable in an axial direction. The foam casing of the skeleton adjoins an edge of the covering cap. To actuate the horn, the covering cap and possibly the entire module is moved in the axial direction, i.e. in the direction of the steering column, until the horn contacts are closed. Between the covering cap and the foam casing encircling it, a gap is provided which is to be as small and regular as possible. On pressing of the covering cap, in addition the cap should not disappear completely, because otherwise the covering cap would lie against the foam casing and the occurring friction would make the actuation of the horn difficult.

It is therefore an object of the invention to provide a vehicle steering wheel in which the gap is kept small and constant on the periphery. Furthermore, as few parts as possible are to be used for the mounting of the covering cap and preferably of the gas bag module, as well.

### BRIEF SUMMARY OF THE INVENTION

This is achieved in a vehicle steering wheel comprising a skeleton embedded in a foam casing and a covering cap having an edge. The covering cap, for actuation of a horn, is mounted so as to be displaceable in an axial direction, the foam casing of the skeleton adjoining the edge of the covering cap. Guides for the covering cap are provided in a region of the edge of the covering cap. The guides are arranged such that and elastically mounted such that upon laterally pressing down the covering cap for actuating the horn, the guides are tilted allowed by a yielding of the foam casing. A jamming of the guides is prevented by the tilting motion. Thus, the movement of the covering cap on actuating the horn is only allowed by the guides in combination with their tilting motion in the elastic foam. Hence, this is a matter of a deliberately elastic arrangement of the guide in the foam casing. Through the fact that the mountings are arranged at the edge of the covering cap, a swivel axis is produced on actuation which lies quite close to the edge of the covering cap, whereby lateral displacements can scarcely still occur with the axial displacement of the covering cap. In prior art, the covering cap or the gas bag module is mounted on the rear side close to its center, i.e. such mounting is offset intensively in radial direction from the edge of the covering cap, whereby a tilting of the covering cap or of the entire module is achieved on actuation of the horn, which is connected with a lateral displacement of the covering cap or of the module.

According to the preferred embodiment, in which the covering cap closes the gas bag module, the gas bag module is connected with the guides close to the edge of the covering cap and is axially displaceable together with the covering cap.

The gas bag module preferably has a cup-shaped receiving housing which is open towards the covering cap and adapted to receive a gas bag. The edge of the housing has extensions projecting laterally outwards towards the edge of the covering cap, the guides being provided on the extensions. Through these extensions, there is achieved a positioning of the guides in the vicinity of the gap.

The guides are, for example, bolts which are formed in one piece on the receiving housing. If the receiving housing is made of plastics, the guides can also be formed thereon in a simple manner. When the bolts are constructed as guides, they also serve to guide restoring springs, by extending through these. The restoring springs, in turn, serve to restore the covering cap or the entire gas bag module.

The guides can be held in bearing bushes, the bearing bushes being mounted on the guides, which are formed by bolts, so as to be non-removable in axial direction and being pressed into the foam casing. By the bearing bushes being secured on the bolts so as to be non-removable in axial direction, the entire gas bag module together with the bearing bushes can be constructed as a pre-assembled unit and can be mounted on the steering wheel in that on putting the module in place, the bearing bushes are simply pressed into corresponding seats in the foam casing.

A detent connection between the skeleton and the gas bag module serves to hold the module inasmuch as the detent connection prevents a removal of the module from the steering wheel by unauthorized persons. The detent connection preferably also serves to provide an axial stop in the initial position of the gas bag module, i.e. when the horn is not actuated.

### BRIEF DESCRIPTION OF THE DRAWINGS

FIG. 1 shows a sectional view through the steering wheel according to the invention in accordance with a preferred embodiment, with the horn not being actuated,

FIG. 2 shows the vehicle steering wheel according to FIG. 1, with the horn being actuated,

FIG. 3 shows a view of the gas bag module from below, the spokes of the steering wheel being indicated,

FIGS. 4a and 4b show a yielding, i.e. a tilting of the mounting into different directions, and

FIG. 5 shows the covering cap completed by the guide, prior to being inserted in the foam casing.

### DETAILED DESCRIPTION OF THE PREFERRED EMBODIMENTS

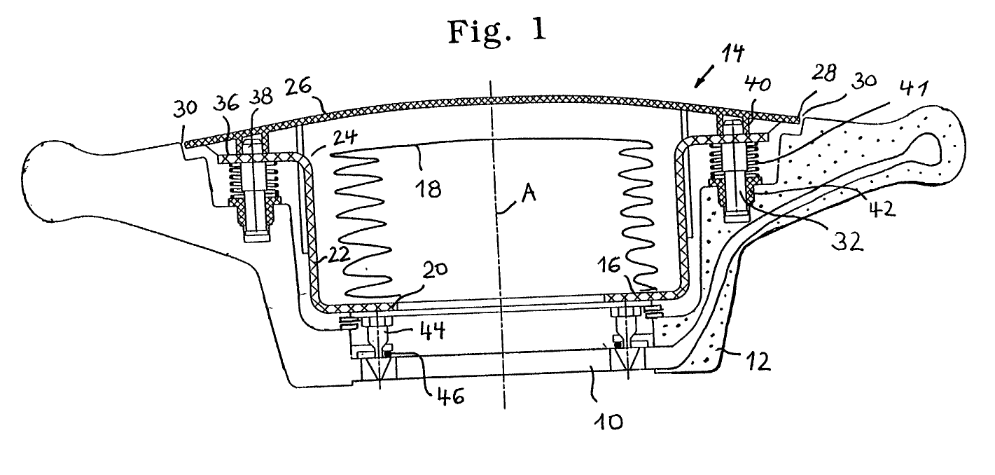

In FIG. 1 a vehicle steering wheel is illustrated, which has a steering wheel skeleton 10 of a die cast material and a foam casing 12 of the skeleton, as well as a gas bag module 14. The skeleton 10 and the foam casing 12 are illustrated in section only in the right-hand half.

The gas bag module has a cup-shaped receiving housing 16 of plastics, which is open towards to the top and in which a gas bag 18 is accommodated. The receiving housing 16 has a base 20 and a surrounding side wall 22 with an upper edge 24. The receiving housing 16 is closed by a covering cap 26 which tears open on unfolding of the gas bag 18 and exposes an outlet opening. The covering cap 26, having a large surface area, has an outer edge 28 which, in the state shown in FIG. 1 and only separated by a narrow gap 30, is adjoined by the foam casing 12 so as to be flush with this edge. The covering cap 26 completely covers the front side of the module.

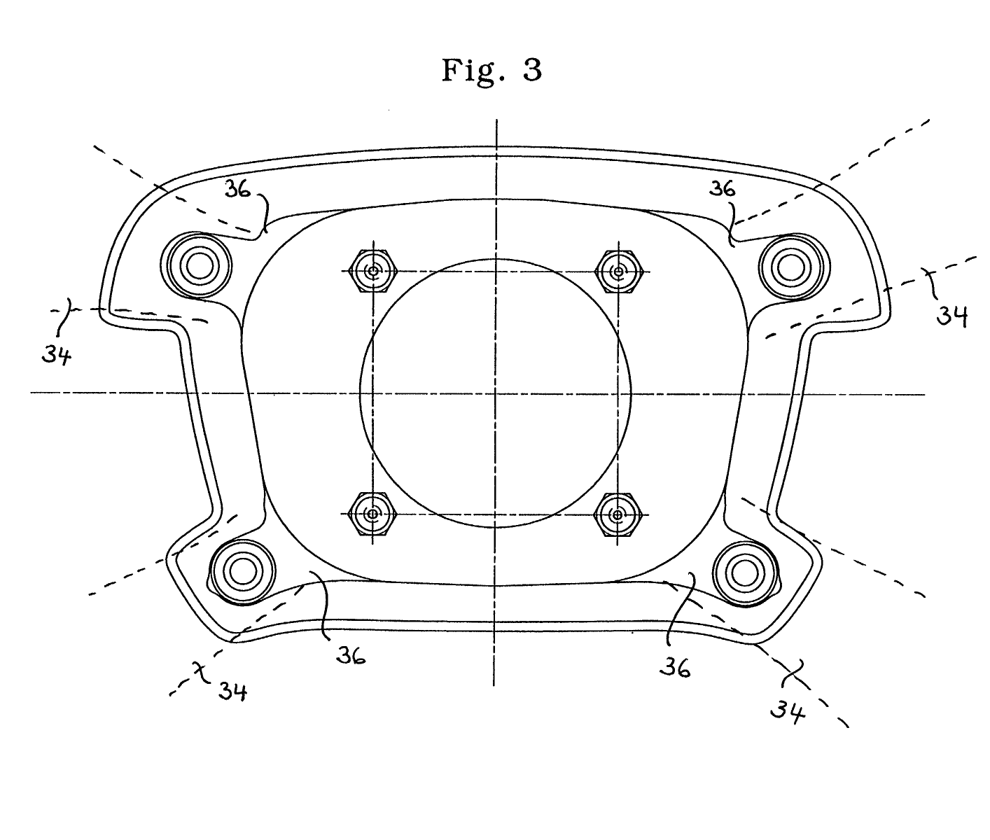

Immediately adjoining the edge 28, as FIG. 3 shows, guides are provided in the form of bolts 32 for the covering cap 26 and the module 14. A guide 32 lies here on each spoke 34.

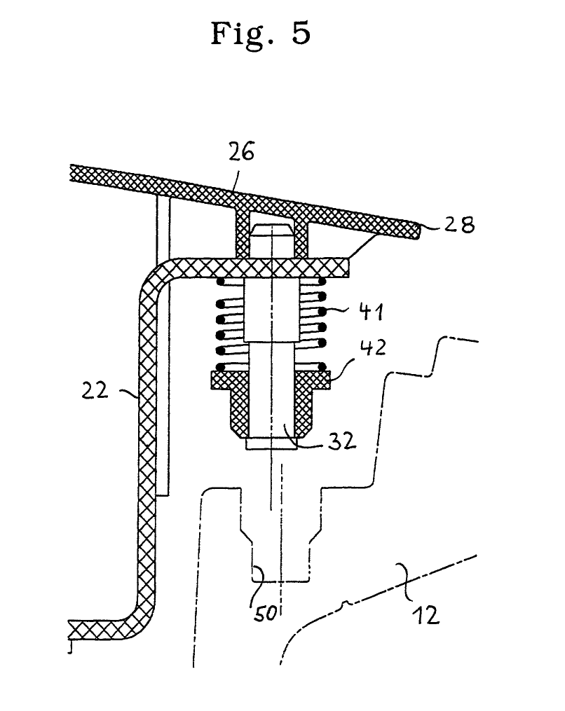

The guides 32 are made of plastics and are formed in one piece on the receiving housing 16. The receiving housing, as can be seen in FIG. 3, has extensions 36 on the edge 24 that project laterally outwards to the edge 28 of the covering cap 26. The guides 32 each have an upwardly directed projection 38 which projects into a seat 40 on the rear face of the covering cap 26, the guide being received in this seat without any lateral play. The individual guides 32, however, are not directly connected with each other. The covering cap 26 is, furthermore, firmly connected with the receiving housing 16 by means of crosspieces which are not shown. Each guide 32 has a longer shaft section which projects downwards and extends through a restoring spring 41. A bearing bush 42 with a collar serving for the abutment of the restoring spring 41 is slipped from below onto each guide 32. The free end of each guide is thickened, in order to prevent a withdrawal of the bearing bushes 42 after installation. The gas bag module 14 is therefore placed on installation together with the guides 32 and the bearing bushes 42 from above onto the skeleton 10 and the foam casing 12 (FIG. 5), until the bearing bushes 42 are pressed into corresponding recesses 50 in the foam casing. Consequently, the guides 32 are mounted elastically in the foam casing 12, and in fact not only axially elastically but also radially elastically, so that the guides 32 together with the bearing bushes 42 are tilted in the foam casing 12 with each lateral pressure onto the covering cap.

On the rear face on the base 20, hooks 44 are provided as part of a detent connection. An elastic detent piece 46, connected with the skeleton 10, additionally belongs to each detent connection, which detent piece 46 engages behind an undercut on the hook 44. The detent connection is constructed such that the detent piece 46 together with detent hook 44 in the initial position shown in FIG. 1 forms the stop for the gas bag module 14, with, however, a displacement within the detent connection being possible in the direction of the axis A and downwards, in order to permit the actuation of the horn.

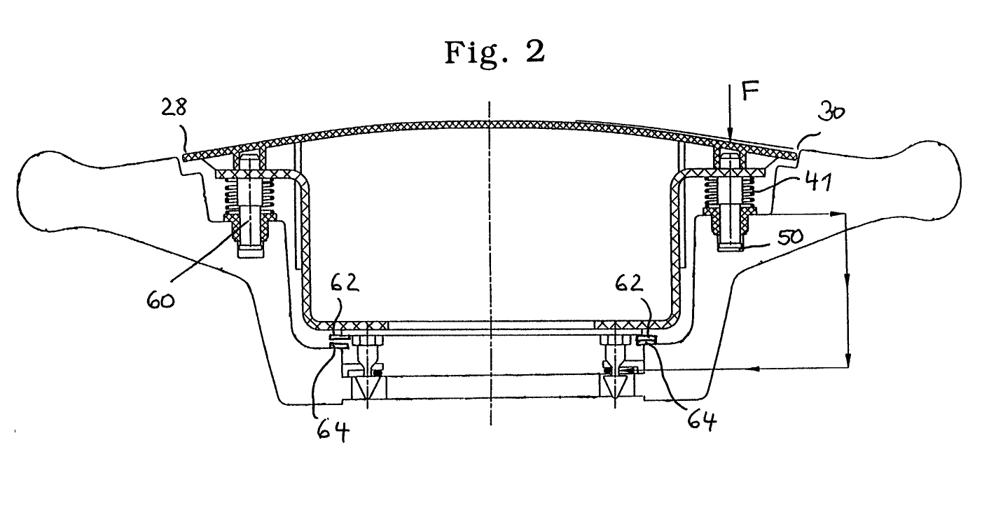

If, as shown in FIG. 2, for example in the region of the edge 28 pressure is applied via the driver's thumb from above in the direction of the arrow, in order to actuate the horn, the restoring spring 40 lying immediately beneath the force introduction point will undergo a deflection. The guide 42 will likewise travel at this point downwards along the bearing bush 42, the recess 50 in the foam casing 42 being so deep that the guide 32 does not strike the base of the recess 50. Through the asymmetrical lateral introduction of force, a swivel movement is brought about around an imaginary rotation axis 60 in the region of the left-hand guide 32. The rotation axis 60 is very close to the edge 28, so that no substantial radial displacement of the edge 28 on the right-hand side is involved with the swiveling of the covering cap 14 downwards, and the gap 30 remains substantially uniform. The slight radial movement components of the guides 32 are permitted by the foam casing 12, which permit a tilting movement of the bearing bushes 42.

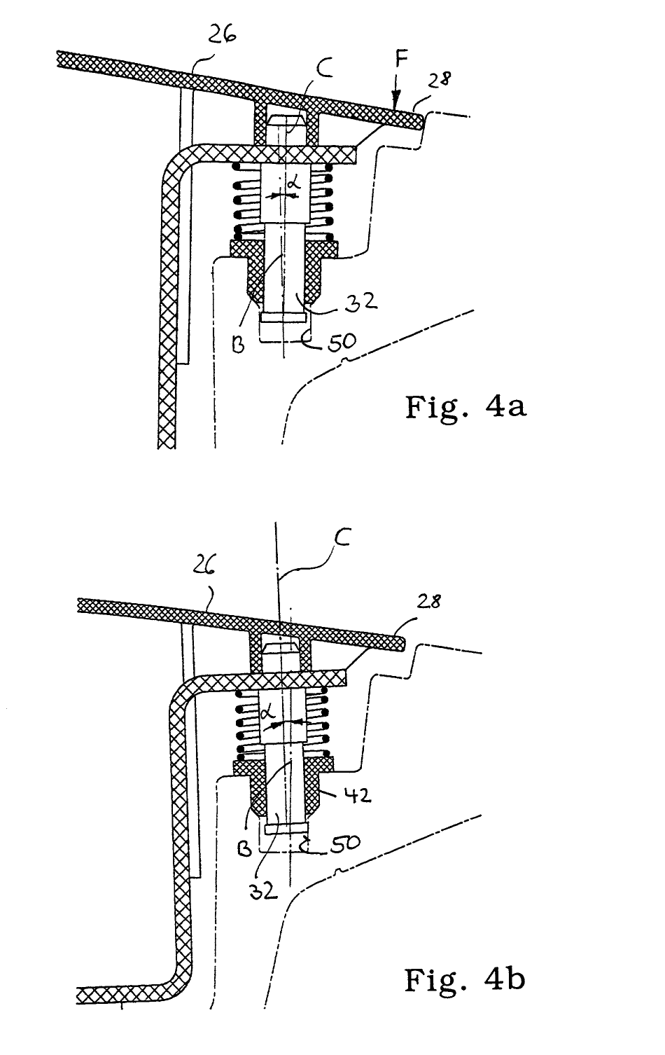

Such a tilting movement of the mounting shown in the right-hand half of FIG. 2 can be clearly seen in FIG. 4. In this case, a force (see also arrow F) which is applied in the region of the mounting illustrated, causes a tilting of the guide 32, 42 in the foam casing. FIG. 4b shows a tilting of the mounting in the reverse direction; this being caused by a pressing down of the covering cap 14 in the region of the left-hand side mounting shown in FIG. 2. According to FIGS. 4a and 4b, the guide 32 has the axis C and the opening 50 has axis B.

In addition, the horn is actuated as soon as horn contacts 62, 64 are in contact.

By utilizing the flexibility of the foam casing 12 and the positioning of the guides 32 as far away from the axis A (FIG. 1) as possible and as close to the gap 30 as possible, the guiding of the gas bag module 14 is made possible with few parts, with precise maintaining of tolerances. Through the elasticity of the foam casing 12, the friction between the restoring springs and their supports, which occurs through a lateral relative movement of these parts with respect to each other in the prior art, is avoided. The entire unit of receiving housing 16, guides 32 and bearing bushes 42 together with the restoring springs 40 aligns on application of a force for horn actuation in the direction of the force.

1. A vehicle steering wheel, comprising
a skeleton embedded in a foam casing and a covering cap having an edge,
said covering cap, for actuation of a horn, being mounted so as to be displaceable in an axial direction, said foam casing of said skeleton adjoining said edge of said covering cap,
guides for said covering cap being provided in a region of said edge of said covering cap, said guides being arranged such that and elastically mounted such that upon laterally pressing down said covering cap for actuating said horn, said guides are tilted allowed by a yielding of said foam casing.

2. The vehicle steering wheel according to claim 1, wherein a gas bag module is provided which is closed by said covering cap and which together with said covering cap is mounted so as to be displaceable in said axial direction, said guides being connected with said gas bag module.

3. The vehicle steering wheel according to claim 2, wherein said gas bag module has a cup-shaped receiving housing which is open towards said covering cap and adapted to receive a gas bag, an edge of said receiving housing having extensions projecting laterally outwards and towards said edge of said covering cap, said guides being provided on said extensions.

4. The vehicle steering wheel according to claim 3, wherein said guides are bolts which are formed in one piece on said receiving housing.

5. The vehicle steering wheel according to claim 3, wherein said receiving housing as well as said guides are made of plastic.

6. The vehicle steering wheel according to claim 2, wherein a detent connection is provided between said skeleton and said gas bag module to support said gas bag module.

7. The vehicle steering wheel according to claim 1, wherein restoring springs are provided, said guides being bolts which extend through said restoring springs.

8. The vehicle steering wheel according to claim 1, wherein bearing bushes are provided, said guides being bolts which are inserted in said bearing bushes, said bearing bushes being mounted on said bolts so as to be non-removable in said axial direction and being pressed into said foam casing.

9. The vehicle steering wheel according to claim 1, wherein said guides are received in said covering cap so as to have no lateral play.

10. The vehicle steering wheel according to claim 1, wherein said module has a front side and said covering cap covers said module entirely on said front side.

11. The vehicle steering wheel according to claim 1, wherein said guides are not directly connected with each other.
